(19) United States
(12) Patent Application Publication
(10) Pub. No.: US 2004/0150289 A1
(43) Pub. Date: Aug. 5, 2004

(54) Universal motor/generator/alternator apparatus

(76) Inventor: Gordon G James, Windham, NY (US)

Correspondence Address: Gordon G James, P O Box 1022, 4828 Route 23, Windham, NY, 12496, US

(21) Appl. No.: 10/476,430

(22) PCT Filed: May 14, 2002
(86) PCT No.: PCT/US02/15478

(51) Int. Cl. H02K 41/00; H02K 21/12; H02K 1/12

(52) U.S. Cl. 310/261; 310/254; 310/12; 310/156.01

(57) ABSTRACT

A universal motor/generator/alternator apparatus comprises: At least one moveable body (e.g., a motor or shuttle)(11) having multiple surfaces (14a-d), when viewed in cross-section, comprising a plurality of magnets or coils (13) on each such surface (14a-d); multiple electrical conductor assemblies (e.g., stator windings or solenoids)(15) surrounding each moveable body (14) which each comprise multiple electrical conductors (15) therein, each electrical conductor (15) in an assembly being positioned so as to be substantially coplanar to a corresponding moveable element (11) surfaces (14a-d) that comprises the magnets or coils (13) and means to either energize the electrical conductor (15) assemblies to thereby create magnetic fields that interact with corresponding magnetic fields in the moveable body (11) causing movement of the body (11); or to mechanically move the moveable body (11) thereby inducing an electrical current in the electrical conductors (15) in the electrical conductor assemblies.

This application claims the benefit of US. Provisional Application Ser. No. 60/291,464, filed May 16, 2001.

The following U.S. patents are deemed to be relevant to the present invention, although not suggestive thereof: U.S. Pat. Nos. 4,996,457; 5,517,099; 5,808,395; 5,818,139; 5,990,590; 6,068,573; 6,072,298; 6,104,112; 6,121,749; 6,138,781; 6,140,731; 6,166,525; 6,232,742; 6,252,325; 6,259,176; 6,259,233; 6,343,433; 6,343,910; and 6,384,555.

The present invention is a novel apparatus that can function in a variety of ways to transform electrical energy into mechanical energy, or vise-versa, depending upon how it is specifically deployed in its various possible embodiments. For example, it can function as a critical component in a generator/alternator. In addition, it can be deployed as an electric motor. The terminology “universal motor/generator/alternator”, as used herein, is therefore intended to Indicate the multiplicity of ways that the person of ordinary skill in the art can utilize this apparatus in its various embodiments. More specifically, these embodiments include (but are not limited to) Its use as an essential component in the following: AC motors (single or multiple phase); AC generators (single or multiple phase); DC motors; DC generators; universal motors; stepper motors; serve motors; switched reluctance (SR) motors; linear motors; pancake motors; and high speed/high acceleration motor The person of ordinary skill in the art will recognize that the present invention is an efficient replacement for the conventional assembly that is now responsible for transforming electrical energy into mechanical energy, or vice-versa, in the foregoing types of electrical/mechanical devices. The art is replete with literature sources from which the person of ordinary skill in the art can design system that utilize the present invention as an essential assembly that is responsible for transforming electrical energy Into mechanical energy, or vice-versa.

In its broadest embodiment, this universal motor/generator/alternator apparatus can be envisioned as comprising at least one moveable body or multiple moving bodies, such as a shuttle or rotor, having multiple surfaces when viewed In cross-section, each surface comprising a plurality of magnets, or coils, thereon; multiple electrical conductor assemblies (for example, stator windings or solenoids) surrounding each movable body, such electrical conductor in an assembly being positioned so as to be substantially coplanar to a corresponding moveable element surface that contains the magnets and means to either energize the electrical conductor In the electrical conductor assemblies to thereby create magnetic fields that interact with corresponding magnetic fields, from the magnets in the moveable body, thereby causing movement of the body; or to mechanically move the moveable body thereby inducing an electric current in the electrical conductors in the electrical conductor assemblies.

In one especially preferred embodiment, the present Invention comprises the following elements: (a) at least one rotor that has multiple surfaces, when viewed In cross-section, comprising a plurality of magnets on each such surface; (b) multiple stator assemblies surrounding each rotor which each comprise multiple windings therein, each stator in the assembly being positioned so as to be substantially coplanar to a corresponding rotor surface that comprises the magnets; and (c) means to either: (i) energy the windings In the stator assemblies to thereby create magnetic fields that interact with corresponding magnetic fields in the rotor causing rotation of the rotor, or (ii) to mechanically rotate the rotor thereby including an electric current in the stator windings assemblies.

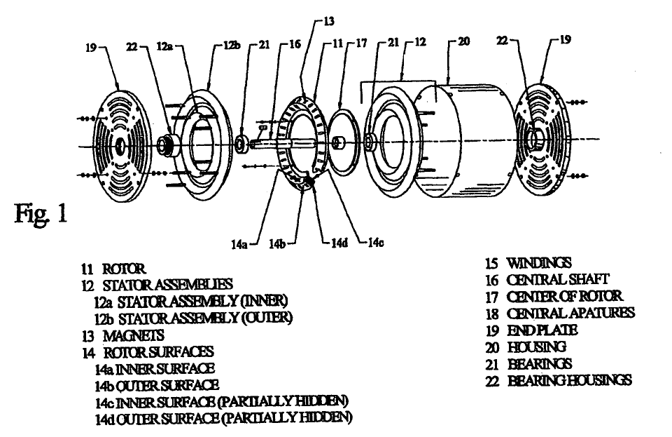

FIG. 1 illustrates, in an exploded perspective view, the second foregoing embodiment showing the rotor 11 and stator assemblies 12a and 12b. The magnets 13, which preferably are permanent, in the depicted rotor embodiment are on four surfaces 14a, 14b, 14c, and 14d, with surfaces 14c and 14d being partially hidden with the opposing sides of 14a and 14b, respectively. The magnets 13 need to be of a material that substantially retains permanent flux density upon repulsion. Representative magnetic materials of this type include, but are not limited to, ceramic ferrite, bonded samarium cobalt, and sintered neodymium-iron-boron (Nd—Fe—B) compositions.

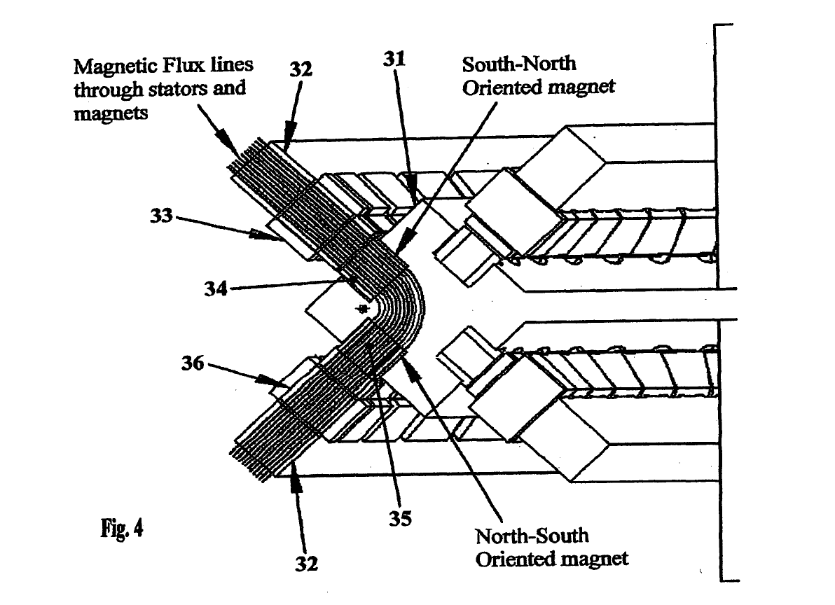

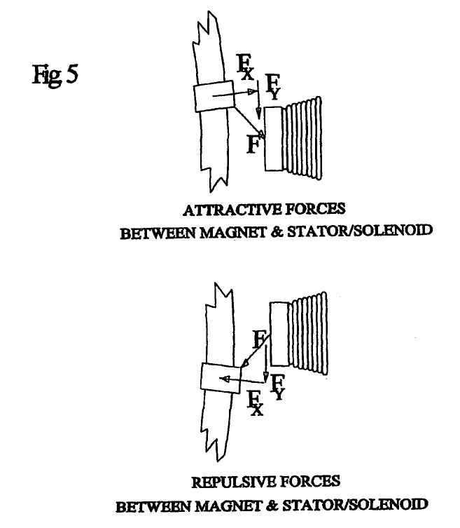

In FIG. 1, stator assemblies 12a and 12b each have a plurality of windings. These windings in each individual stator, which can be of any winding configuration (e.g. a conical shaped co configuration), in the assembly are positioned so that they are substantially coplanar (or at a substantially 180-degree orientation) to a corresponding rotor surface comprising the magnets. Preferably, the respective, associated magnetic fields on the rotor and stator assemblies are at substantially 90-degree to one another to avoid undesired eddy current interference (as seen in FIG. 4 to be described below). Such an arrangement allows for a high degree of magnetic coupling allowing the depicted platform to have very high flux efficiencies as compared to a conventional motor/generator/alternator configuration lacking this novel arrangement The stator assemblies can surround the rotor except at the power take-off surface. Additionally, the power take off surface can comprise a planetary gear set and an output shaft or a protruding gear located within the housing 20 of the apparatus. The windings comprise a plurality of connecting points for energizing the windings both with and without active control of the system. A central shaft 16 fixedly-joined at 17 to the center of the rotor and traversing central apertures 18 in each stator assembly 12a and 12b and endplates 19 complete the assembly.

The general rotor/stator shown in FIG. 1 Is adapted to be joined to conventional means to function as a motor, as a generator, or as an alternator using techniques that are well known in the art For example, the structure win function as a motor if one energize the windings in the stator assemblies by supplying electrical current to such wings by conventional means (not shown) to hereby create magnetic fields (acting at 90-degrees to the current flowing direction) that interact with corresponding magnetic flux lines, generated by the permanent magnets in the rotor, causing the moveable body to rotate. Conversely, the assembly shown in FIG. 1 will function as a generator if one mechanically rotates the shaft and its attached rotor (using conventional means not depicted) to induce an electric current in the win.

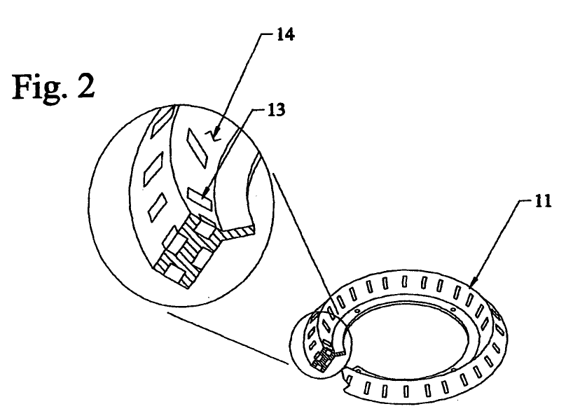

FIG. 2 illustrates a cross-sectional view of a rotor (11) having a square cross-section, which shows the rotor surfaces (14) and permanent magnets (13) more clearly. Preferred rotor cross-sectional shapes include a square, triangular, multi-sided or bilateral (namely a flat plate with two or more fields) configurations. All rotor configurations for this invention will consist of a radial 360-degree flux field on multiple surfaces of the rotor, or rotors.

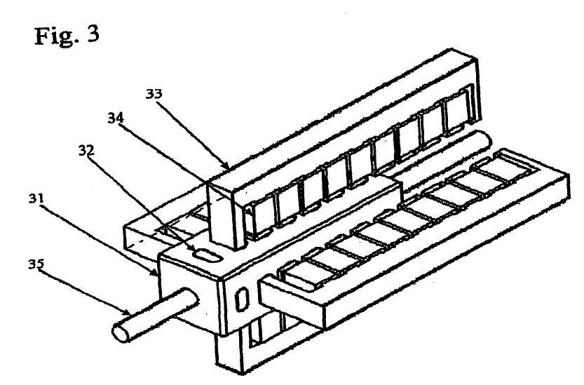

FIG. 3 illustrates an alternative embodiment where a linear motor system is constructed that employs the same general principles underlying the operation of the system illustrated in FIG. 1 with regard to the positioning of the magnets and the surrounding assemblies, which contain the electrical conductors that generate magnetic fields when an electrical current is introduced. This system comprises of a movable shuttle, on a guide rod (35), with multiple permanent magnets (32) embedded in its surface, a plurality of solenoid assemblies (33) surrounding the shuttle with each solenoid in the assembly being positioned so as to be substantially coplanar to a corresponding surface in the shuttle that comprises the magnets. Means are provided to either energize the solenoids to thereby create magnetic fields that interact with corresponding magnetic fields from the shuttle causing movement of the shuttle or to mechanically move the shuttle thereby inducing an electric current in the solenoids in the solenoid assemblies.

One possible configuration of the magnets and stators/solenoids can be seen In FIG. 4, the magnetic flux 18 generated by the windings 33 and 36 (right hand wound coil and left hand wound coil wired In series) In the magnetic material of the stator/solenoids 32. The magnetic flux is then focused and concentrated across the air-gap by the permanent magnet, 34 contained by the rotor/scuttle (31). The magnetic flux then moves through the rotor/shuttle (31) and the opposing magnet (35) to be refocused across the second air-gap and into the opposing stator/solenoid 36 (left hand wound coil). The magnetic flux then completes its circuit by traveling through free space or a magnetic material.

FIG. 5 Illustrates a cross-section of the system showing magnetic flux path. Not shown, for purposes of clarity only, in this Figure is the return path (to complete the magnetic circuit) of the magnetic flux through free space. The magnetic flux at this point could also be coupled into a magnetic material to guide it thereby reducing the total reluctance of the circuit and Increasing the force exerted on the magnets. Also not shown in this Figure is the mirror image configuration of the magnetic flux path through the opposed stator/solenoid assembly.

By wiring the stator/solenoid windings to use the natural inherent rotating magnetic field generated by a alternating electrical current or by applying an active control system to energize the winding pairs in sequence, alternating attractive and repulsive forces (in the AC case) or sequenced attractive forces (in the controlled case) can be applied to the rotor/shuttle to transmute electrical energy into mechanical energy thereby moving the rotor/shuttle and any appendages that might be attached to the rotor/shuttle.

To see the focusing effect of the permanent magnets and the resulting increase in the force applied to the rotor/shuttle it is best to reduce the system to its smallest possible elements, i.e., one set of magnets and a corresponding set of stator/solenoids. The forces operating on these elements during the attractive and repulsive portions of the cycle (in the AC case) or the sequenced attractive forces (in the controlled DC case) can then be analyzed using commn magnetic circuit methods:

In the attractive phase, the magnetic flux through the stator/solenoid and rotor/scuttle, can be mathematically represented by the following (statically):

Y_{m,core}=nI/[2R₁+2(x1.u₀A_{ag})+2Y_{m,pm}+(x3/u₀A_{rg})]

Where:

n=number of turns in the coil

I=current in amps

R₁=Reluctance in the stator/solenoid core

x1/u₀A_{ag}=Reluctance in air gap between stator/solenoid face and rotor/shuttle face

Y_{m,pm}=Flux of permanent magnets

x2/u₀A_{mg}=Reactance in air gap between rotor/shuttle magnet

x3/u₀A_{rg}=Reluctance in air gap between the opposed stator/solenoid rear faces (return path)

x1, x2, x3=magnetic path length in the respective air gaps

A_{zz}=cross sectional area in the corresponding air gaps

Dynamically is equation becomes:

dY_{m,core}/dΦ={n dI/dt/[2R₁+((dx1/dΦ)/u₀A_{ag})+(x2/u₀A_{mg})+(x3/u₀A_{rg})]}+2Y_{m,pm}

Where dΦ=change in the linear or angular displacement of the shuttle/rotor body, and the magnetic flux through the stator/solenoid and rotor/shuttle during the repulsive phase can be mathematically represented by.

dY_{m,core} /dΦ={−n dI/dt/ [2R₁+2((dx1/dΦ)/u₀A_{ag})+(x2u₀A_{mg})+(x3/u₀A_{rg})]}+2Y_{m,pm}

From the equations previously defined, we can calculate the force exerted by each stator/solenoid winding set on the opposed magnet sets during both the attractive and repulsive phases of the cycle, see FIG. 5 as a reference.

Fₘₐₓ=−1/ (u₀A_{ag})*Y²_{m,core} [Statically attractive]

Fₘₐₓ=1/(u₀A_{ag})*Y²_{m,core} [Statically repulsive]

With Y_{m,core}=Bₐᵥ*A_{ag} these expressions ca be rewritten as

Fₘₐₓ=−A_{ag}/u₀*Bₐᵥ² [Statically attractive]

Fₘₐₓ=A_{ag}/u₀*Bₐᵥ² [Statically repulsive]

Since only the component of the force that acts on the rotor/shuttle contributes to the movement of the rotor/shuttle, we must decompose the force vector into its individual component. Thus in FIG. 5 only the F_{y} component is of interest. Therefore the force degrades as a sinusoidal as the magnet approaches the stator/solenoid face.

F_{y}=Fₘₐₓ Sin Ø

Where Ø=angle between the face of the magnet and the face of the stator/solenoid. And dynamically the expression becomes:

dF_{y}/dΦ=Fₘₐₓd(Sin Ø)/dΦ

Given the implications of these equations, we conclude the following: The air gap force is proportional to the air gap flux squared as well as the flux density squared.

By using the permanent magnets the flux density in the air gap during the attractive phase of the cycle is effectively increased, confined and focused Into the smallest possible cross-sectional area, i.e. that of the permanent magnet, since the flux will follow the path of least resistance through the magnet.

Minimizing the cross-sectional area and maximizing the flux dnsity in the air gap maximizes the forces exerted on the rotor/shuttle during the attractive and repulsive phases of the de.

As indicated before, the person of ordinary skill in the art can utilize the assembly illustrated in FIG. 1 in a wide variety of systems using other conventional components that are now employed with the conventional and differing rotor/stator configuration known to the art. The person In that art can easily configure any of the following configurations by consulting standard references (see, for example, Electric Motor Repair, Third Edition by Robert Rosenberg and Hand et al; Holt, Rinehart and Winston, 1970, which is incorporated herein in its entirety by reference)

What follows is a non-exhausting list of the preferred potential configuration:

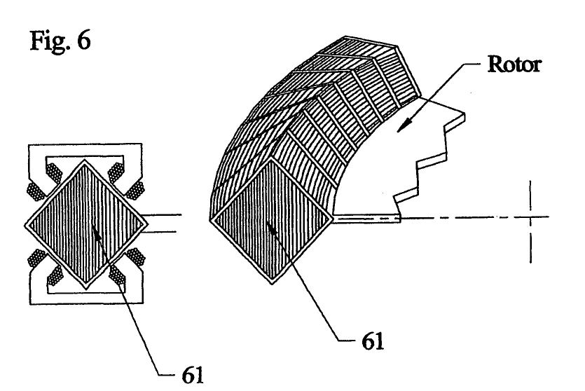

AC or DC Induction Motor. An induction motor can be constructed by embedding steel laminations (61) inside the rotor, see FIG. 6.

AC Motor: If no conventional active controls are employed, the motor can function either as a single phase or multi-phase AC motor. The windings belonging to the same phase may be connected in either series or parallel mode so as to opera the motor at one of the two different operating voltages.

DC Motor: A commutator cam be employed so that the motor functions as a DC motor.

Universal AC/DC Motor: In this ease, a commutator is employed and the windings are connected so as to operate the motor in this fashion.

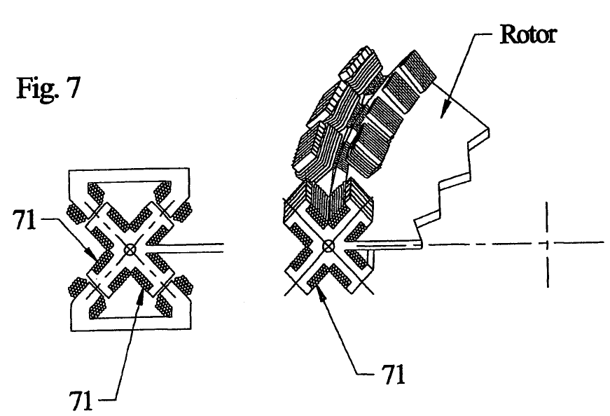

Wound-rotor Motor: Thus the windings (71) would be attached to the rotor (induction-type motor), see FIG. 7.

Brushless/Servo Motor. Here, an active control system is used and the stator windings are configured in a three-phase winding arrangement with a wye connection to produce trapezoidal torque characteristics.

Pancake Motor. A pancake motor can be considered as any motor having a large diameter compared to Its thickness. Commonly referred to as a torque motor, these motors offer direct drive capability without the use of mechanically transmissions to deliver power to the load.

Stepper Motor. An active control system is used to pulse and hold the rotor thereby moving it in discrete increments of rotation allowing the motor to function as a stepper motor.

Switched Reluctance Motor: In this embodiment, an active control system is used to energize the coil wind-, Independently connected In phase pairs, in a sequential pattern to develop a rotating magnetic field. The mile permanent magnets are configured In pole pairs so that the pole pairs follow the rotating magnetic fields.

High spped/high acceleration Motor: An active control system is used to energize the coil windings with a varying high frequency sinusoidal electric field.

Motor/Generator/Alternator: Either with or without active control of this system, the windings are controlled externally so that portions of the windings may be switched on or off allowing this system to utilize the kinetic energy of the rotor and attached assemblages to produce an electric current For example, this current can be fed back onto a local power grid.

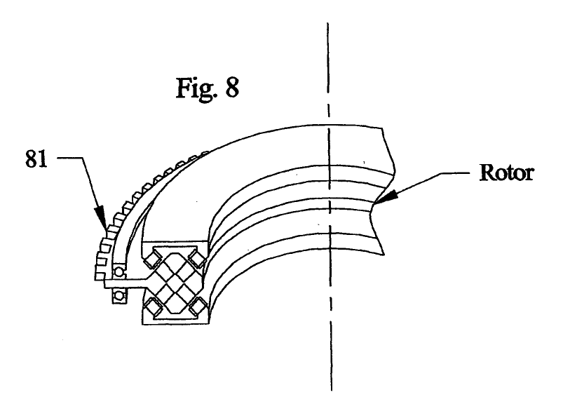

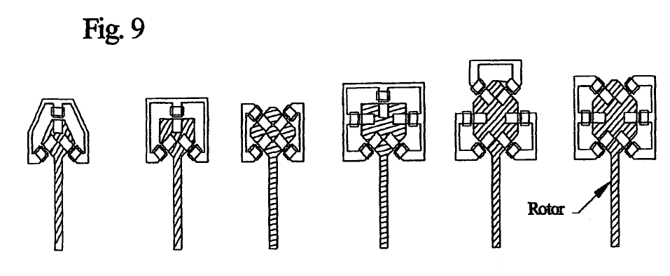

Generator/Alternator. Either with or without active control of this system, the windings are controlled externally so that portions of the windings may be switched on or off allowing this system to utilize the kinetic energy of the rotor and attached assemblages to produce an electric current by the interaction with the permanent magnets. Furthermore, this current can be fed back onto a local power grid. And if desired, the stator assemblies can completly surround the rotor except at the power Input surface, which comprises of either a planetary gear set located within the apparatus housing and an input shaft or a gear protruding from the surface of the motor housing. FIG. 8 illustrates how the rotor can be modified to incorporate a planetary gear set (81).

The foregoing description and the accompanying Drawings should not be construed in a limiting sense since they are intended to merely illustrate certain embodiments of the claimed invention. The scope of protection sought Is set forth in the claims follow.

I claim:

1. A universal motor/generator/alternator apparatus that comprises:
(a) at least one moveable body having multiple surfaces, when viewed in cross-section, comprising a plurality of magnets or coils on each such surface;
(b) multiple electrical conductor assemblies surrounding each moveable body which each comprise multiple electrical conductors therein, each electrical conductor In an assembly being positioned so as to be substantially coplanar to a corresponding moveable element surface that contains the magnets; and
(c) means to either:
(i) energize the electrical conductor in the electrical conductor assemblies to thereby create magnetic fields that interact with the moveable body causing movement of the body; or
(ii) to mechanically move the moveable body, comprising of a plurality of magnet:, thereby inducing an electric current in the electrical conductors in the electrical conductor assemblies

2. A universal motor/generator/alternator apparatus that comprises:
(a) at least one rotor having multiple surfaces, when viewed in cross-section, comprising a plurality of magnets on each such surface,
(b) multiple stator assemblies surrounding each rotor where each comprise of multiple winding therein, each stator in the assembly being positioned so as to be substantially coplanar to a corresponding rotor surface that comprises the magnets; and
(c) means to either:
(i) energize the windings in the stator assemblies to thereby create magnetic fields that interact with corresponding magnetic flux lines in the rotor causing rotational movement; or
(ii) to mechanically rotate the rotor thereby inducing an electric current in the windings held by the stator assemblies.

3. An apparatus as claimed in claims 1 or 2, wherein by utilizing permanent magnets embedded in the surface of the rotor or shuttle, the magnetic flux can be focused and concentrated thereby reducing the reluctance of the magnetic circuit, effetely increasing the flux density and the amount of force that Is exerted on the rotor, and optionally reducing the air gap between the stator and rotor and coupling together pairs of stators with a magnetic material .

4. An apparatus as claimed in claims 1 or 2, wherein the array of permanent magnets is designed to increase flux density.

5. An apparatus as claimed in claims 1 or 2, wherein the array of permanent magnets encompasses a 360-degree configuration coplanar

6. An apparatus as claimed in claims 1 or 2, wherein the magnetic fluxes correspond to 360degree radial and 360-degree axial envelope to generate interactive magnetic Rid&

7. An apparatus as clod in claims 1 or 2, wherein the cross-sectional view of the moveable body or rotor is of a geometric shape to increase flux density.

8. An apparatus as claimed in claims 1 or 2, wherein flux density is increased by utilizing permanent magnets embedded in the surface of the rotor or shuttle wherein the permanent magnets encompass a 360-degree configuration on coplanar surface to focus and concentrate magnetic flux thereby reducing the reluctance of the magnetic cut to effectually increase the flux density and the amount of force that is exerted on the rotor, and optionally reducing the air gap between the stator and rotor and coupling together pairs of stators with a magnetic materil.

9. An apparatus as claimed in claims 1 or 2, wherein the electrical conductors/windings are of conical shape.

10. An apparatus as claimed in 1 or 2, wherein the electrical conductor/windings are positioned to increase flux density, such as being normal to the rotor surface containing the magnets.

11. An apparatus as claimed in claims 1 or 2, wherein the electrical condutors/windings correspond to 360-degree radial and 360-degree axial envelope to generate interactive magnetic fields.

12. An apparatus as claimed in claim 1, wherein a linear motor comprising a linear moveable shuttle as the moveable body and a linear assembly of solenoids as the electrical conductor assemblies.

13. An apparatus as claimed in claim 2 in a pancake motor.

14. An apparatus as claimed in claim 2 in a single-phase AC.

15. An apparatus as claimed in claim 2 in a multi-phase AC motor.

16. An apparatus as claimed in claim 2 in a DC motor.

17. An apparatus as claimed in claim 2, in a universal AC/DC.

18. An apparatus as claimed in Clam 2, in a brushless/servo motor.

19. An apparatus as claimed in claim 2 in a stepper motor.

20. An apparatus as claimed in claim 2 in a switched reluctance (SR).

21. An apparatus as claimed in claim 2 in a speed/high acceleration motor.

22. An apparatus as claimed in claim 2, in a motor/generator/alternator.

23. An apparatus as claimed in claim 2 in a generator/alternator.

24. An apparatus as claimed in claim 2 in a servomotor.
